(19) United States
(12) Patent Application Publication
(10) Pub. No.: US 2026/0273449 A1
(43) Pub. Date: Sep. 17, 2026

(54) A UNIT DESIGN AND PROCESS FOR DIRECT CAPTURE OF CARBON DIOXIDE FROM AIR

(71) Applicant: SHELL USA, INC., Houston, TX (US)

(72) Inventors: Sayee Prasaad BALAJI, Amsterdam (NL); Timothy Michael NISBET, Amsterdam (NL); Ghata Manishkumar NIRMAL, Bangalore North (IN)

(21) Appl. No.: 18/873,765

(22) PCT Filed: Jun. 19, 2023
(86) PCT No.: PCT/EP2023/066403

§ 371 Date: Dec. 11, 2024

(30) Foreign Application Priority Data
Jun. 21, 2022 (EP) 22180014.7

(51) Int. Cl. B01D 53/04; B01D 53/14; B01D 53/18

(52) U.S. Cl. CPC B01D 53/0446; B01D 53/1475; B01D 53/18; B01D 2257/504

(57) ABSTRACT

Implementations of the disclosed subject matter provide a process for capture of carbon dioxide from a gaseous feed stream. The process may include a direct air capture (DAC) unit comprising: a first and second inlet faces located on opposite sides of the DAC unit. A sorbent material may be located inside the DAC unit and at or behind each of the inlet faces. An outlet may be located at the top of the DAC unit and may provide an exit gaseous outlet stream. The exit gaseous outlet stream may have a flow that is produced by at least one fan. The process may include receiving a gaseous feed stream at the inlet faces. The gaseous feed stream may have an average CO2 concentration greater than 95% of the CO2 concentration of ambient air, by minimizing reingestion of the exit gaseous outlet stream, for any wind direction and any wind speed.

### TECHNICAL FIELD OF THE INVENTION

The present invention relates to a direct air capture (DAC) unit design and process for capturing carbon dioxide (CO₂) from a gaseous feed stream. More specifically the present invention relates to a module design and process for capturing carbon dioxide (CO₂) from a gaseous feed stream, wherein the gaseous feed stream has an average CO₂ concentration greater than 95% of the CO₂ concentration of ambient air, and wherein the ambient air has any wind direction and any wind speed.

### BACKGROUND

Direct air capture (DAC) of carbon dioxide from the air has been proposed as one way of addressing human induced climate change. Current estimates place global levels of carbon dioxide in the atmosphere at around 420 parts per million. This is expected to rise to around 900 parts per million by the end of the 21st century. Hence, DAC represents one of a range of technologies that can be employed to reduce the environmental impact of greenhouse gases like carbon dioxide and help the transition to a low carbon global economy.

Typical DAC systems take large quantities of air (or other conditioned gaseous atmosphere) which is pumped as a feedstream through a unit that contains a sorbent substance that removes the carbon dioxide from the feedstream. Over time the sorbent becomes loaded with captured carbon dioxide. Next, the captured carbon dioxide in the sorbent is extracted from the sorbent in the regeneration step. Regeneration may involve thermal or chemical processes depending upon the type of sorbent material that is selected for use in the DAC process. Upon regeneration the captured carbon dioxide is released from the sorbent and can be used to manufacture sustainable fuels, chemicals, in food and beverage production or in carbon capture and sequestration (CCS) in order to create a net negative carbon process. The energy input to the DAC system can comprise of thermal energy in the form of steam, and electrical energy for both the absorption (to move the air through the DAC unit) and regeneration (to regenerate the CO2 from the sorbent) steps.

In general, DAC is a capital intensive process due to the necessity to process a large amount of air. Therefore, the productivity of the DAC unit is highly important in the total cost of CO₂ captured. If the productivity of the DAC unit decreases, then the cost of CO₂ captured will increase. Thus, it is imperative to maintain optimum (high) productivities of the DAC unit so that the cost is minimized.

### BRIEF SUMMARY

According to an embodiment of the disclosed subject matter, a process may include a direct air capture (DAC) unit comprising: a first and second inlet faces located on opposite sides of the DAC unit. A sorbent material may be located inside the DAC unit, and at or behind each of the first and second inlet faces. An outlet may be located at the top of the DAC unit and the outlet may provide an exit gaseous outlet stream. The exit gaseous outlet stream may have a flow that is produced by at least one fan. The process may include receiving a gaseous feed stream at the inlet faces, and the gaseous feed stream may have an average CO2 concentration greater than 95% of the CO₂ concentration of ambient air which may have any wind direction and any wind speed.

Implementations of the disclosed subject matter provide a process for capturing carbon dioxide (CO₂) from a gaseous feed stream using a DAC unit, wherein the gaseous feed stream has an average CO₂ concentration greater than 95% of the CO₂ concentration of ambient air, and wherein the ambient air has any wind direction and any wind speed. The disclosed subject matter allows for improved efficiency and reduced costs in the overall DAC process. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example process and side view according to an implementation of the disclosed subject matter.

FIG. 2 shows an example process and front view according to an implementation of the disclosed subject matter.

FIG. 3 shows an example process and top view according to an embodiment of the disclosed subject matter.

FIG. 4 shows an example process and top view according to an embodiment of the disclosed subject matter.

FIG. 5 shows an example process and side view according to an implementation of the disclosed subject matter.

FIG. 6 shows an example process and side view according to an implementation of the disclosed subject matter.

FIG. 7 shows an example process and side view according to an implementation of the disclosed subject matter.

FIG. 8 shows an example process and side view according to an implementation of the disclosed subject matter.

FIG. 9 shows an example contour map of the CO₂ concentrations according to an implementation of the disclosed subject matter.

### DETAILED DESCRIPTION

In general, a problem or disadvantage of the DAC units that are known in the art is a decrease in CO₂ productivity of the module or DAC unit due to ingestion of the depleted CO₂ air at different wind conditions. The present invention solves this problem by increased CO₂ productivity, leading to lower CO₂ capture cost.

The present invention is a module design for a DAC unit for capturing CO₂ from the air using either a solid or liquid sorbent. During adsorption/absorption, air is flowed through the DAC unit via fans and the air is contacted with the sorbent which then captures the CO₂ from the air. The CO₂ depleted air is vented to the atmosphere at the outlet. Since DAC is a process that may be deployed at a large scale and is subject to fluctuations in the wind speed and direction at a particular location, it is important to prevent the module from reingesting the CO₂ depleted air that comes out at the exit of the module. This is because reingestion of CO₂ depleted air reduces the CO₂ productivity—the present invention solves this problem.

According to an embodiment, the present invention minimizes the ingestion of CO₂ depleted air by the DAC unit for all wind conditions and speeds by optimizing several design parameters. The DAC unit according to the present invention is designed in such a way that the average concentration of CO₂ at all inlet faces is greater than 95% of the CO₂ concentration of ambient air by minimizing reingestion of the exit gaseous outlet stream, for any and all wind directions and wind speeds wherever geographically the DAC unit may be operating.

According to an embodiment of the present invention, a process for capture of carbon dioxide from a gaseous feed stream may include a direct air capture (DAC) unit. The DAC unit may include 2 or more inlet faces. As an example, the DAC unit may include a first inlet face and a second inlet face, and the first and second inlet faces may be on opposite sides of the DAC unit. In a specific embodiment, the second inlet face may be a shadow inlet face. A shadow inlet face may be a downwind face when the wind direction is not parallel to the shadow inlet face. The DAC unit may have at least two faces, at least four faces, and may have more than 4 faces.

The DAC unit may also include a sorbent material located at or behind each of the inlet faces and sorbent material may be located inside the DAC unit. The sorbent material may be a liquid or solid sorbent material. A typical liquid sorbent material is an aqueous solution of an alkali metal hydroxide, amino acid or an amine. A typical solid sorbent material is an alkali metal carbonate or amine component on a support material such as alumina, silica, titania or carbon.

According to an embodiment, the DAC unit may have a height that is equal to the distance between the highest point of the DAC unit not including any extensions and/or chimneys and the lowest point of the DAC unit not including the void space (as further described below). Further, the DAC unit may have a length that is equal to the length of the longest of the first and second inlet faces. For example, if the first inlet face has a length of 3 m and the second inlet face has a length of 2 m, the length of the DAC unit would be 3 m, which is equal to the longer length of 3 m of the first inlet face. For example, if the first inlet face has a height of 15 m and the second inlet face has a height of 13 m, then the height of the DAC unit would be 15 m, which is equal to the distance between the highest point of the DAC unit (not including any extensions or chimneys) and the lowest point on the DAC unit (not including any void space). In an embodiment, the DAC unit may have a height/length ratio of greater than 0.5, greater than 0.7, and greater than 1.

When in operation, the DAC unit may receive a gaseous feed stream at each of the first and second inlet faces. According to the present invention, the gaseous feed stream may have an average CO₂ concentration greater than 95% of the CO₂ concentration of ambient air by minimizing reingestion of the exit gaseous outlet stream, and the ambient air may have any wind direction and any wind speed. Regarding wind direction and wind speed, for example, the DAC unit may be operated in any geographic location and thus may be exposed to any wind direction and any wind speed in the surrounding environment.

The DAC unit may also include an outlet located at the top of the DAC unit. The outlet may provide an exit gaseous outlet stream that is exhausted back into the ambient air or atmosphere. The exit gaseous outlet stream may have a flow that is produced by at least one fan. Flow as used herein may refer to movement of a stream, for example, movement of the gaseous feed stream and/or exit gaseous outlet stream. The exit gaseous outlet stream is a CO₂ depleted gaseous stream. As described above, according to an embodiment, the DAC unit may provide an exit gaseous outlet stream. The exit gaseous outlet stream may have an exit velocity of less than 15 m/s and greater than 2 m/s, and less than 10 m/s and greater than 5 m/s.

According to an embodiment, the process for capture of carbon dioxide from a gaseous feed stream, as described herein, may further comprise a direct air capture (DAC) unit that may include 1) an inlet air section, 2) a sorbent section, and 3) an outlet air section. The DAC unit may receive a gaseous feed stream at the inlet air section. At least part of the gaseous feed stream may be contacted with a sorbent material located within the sorbent section. An exit gaseous outlet stream may be provided from the outlet air section. The total pressure loss across the inlet and outlet air sections may be maintained at less than 200 Pa. The gaseous feed stream may have a volumetric flow within the sorbent section, and the volumetric flow may have a maximum flow and a minimum flow. The minimum flow may be maintained to be within a range of 0-20% lower than the maximum flow over the entire sorbent section.

In an embodiment, the outlet located at the top of the DAC unit may further comprise a plurality of exit channels. The exit velocity of the exit gaseous outlet stream may be based on the area of each exit channel in the plurality of exit channels. Further, each exit channel in the plurality of exit channels may include a fan. The outlet of the DAC unit may also include a chimney.

According to an embodiment, the DAC unit may further comprise two louvers located at the top of the DAC unit. The louvers may extend proximate and at an angle relative to the first and second inlet faces. The DAC unit may also include more than two louvers located at the top of the DAC unit. In another embodiment, the DAC unit may also include two louvers located at the bottom of the DAC unit. The louvers may extend proximate and at an angle relative to the first and second inlet faces. The DAC unit may also include more than two louvers located at the bottom of the DAC unit. According to another embodiment, the DAC unit may further include four louvers, where two louvers are located at the top of the DAC unit and two louvers are located at the bottom of the DAC unit. All four louvers may extend proximate to the inlet faces, and each louver may extend at an angle relative to the two inlet faces.

According to an embodiment, the process may further comprise a void space located beneath the DAC unit. The void space may have a void height that is equal to the distance from a solid supporting plane beneath the DAC unit to the bottom of the DAC unit. The void height may be greater than 0.5 m, greater than 1 m, and greater than 2 m. The solid supporting plane may be any surface beneath the DAC unit, for example, the ground, a structure, a ship/vessel, or any other solid supporting plane that may provide support beneath the DAC unit.

For the purposes of promoting an understanding of the principles of the invention, reference will now be made to the embodiments illustrated in the accompanying drawings, which are described in more detail below. The embodiments disclosed herein are not intended to be exhaustive or limit the invention to the precise form disclosed in the following detailed description. The invention includes any alterations and further modifications in the illustrated devices and described methods and further applications of the principles of the invention as set forth in the claims.

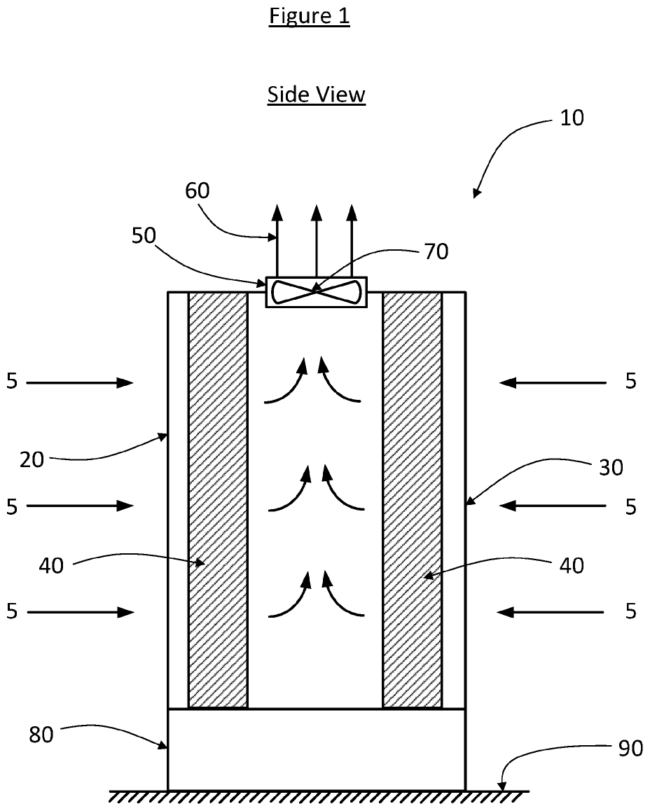

FIG. 1 shows an example process according to an implementation of the disclosed subject matter. In particular, FIG. 1 shows a side view of a DAC unit according to an embodiment of the present invention. As shown in FIG. 1, a process for capture of carbon dioxide from a gaseous feed stream 5 may include a direct air capture (DAC) unit 10. The DAC unit 10 may include 2 or more inlet faces 20, 30. As an example, the DAC unit 10 may include, as shown, a first inlet face 20 and a second inlet face 30. The first and second inlet faces 20,30 may be on opposite sides of the DAC unit 10, as shown in FIG. 1. Although not shown in FIG. 1, the DAC unit 10 may have at least two faces, at least four faces, and may have more than 4 faces.

As shown in FIG. 1, the DAC unit 10 may also include a sorbent material 40 located at or behind each of the inlet faces 20, 30 and the sorbent material 40 may be located inside the DAC unit 10. The sorbent material may be a liquid or solid sorbent material.

Also shown in FIG. 1, the DAC unit 10 may also include an outlet 50 located at the top of the DAC unit 10. The outlet 50 may provide an exit gaseous outlet stream 60, and the exit gaseous outlet stream 60 may have a flow that is produced by at least one fan 70.

The DAC unit 10 may further comprise a void space 80 located beneath the DAC unit and the DAC unit 10 may be operated on a solid supporting plane 90.

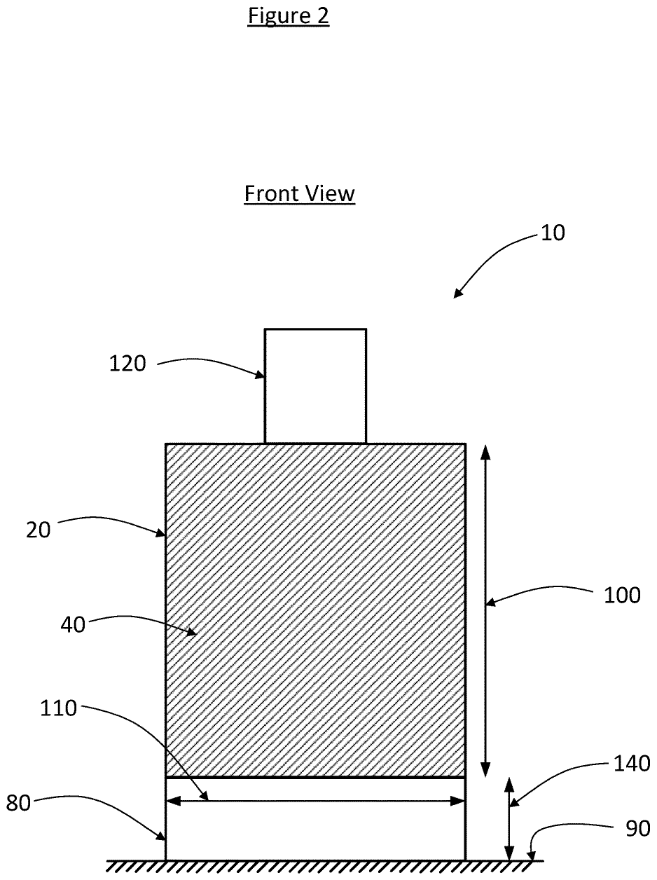

FIG. 2 shows an example process according to an implementation of the disclosed subject matter. In particular, FIG. 2 shows a front view of a DAC unit 10 according to an embodiment of the present invention. As shown in FIG. 2, a direct air capture (DAC) unit 10 may include an inlet face 20 and a sorbent material 40 located at or behind the inlet face 20. The DAC unit 10 may have a height 100 that is equal to the distance between the highest point of the DAC unit (not including any extensions and/or chimneys) and the lowest point of the DAC unit (not including any void space, e.g., void space 80), as shown. Further, the DAC unit 10 may have a length 110 that is equal to the length of the longest inlet face. In an embodiment, the DAC unit 10 may have a height/length ratio of greater than 0.5, greater than 0.7, and greater than 1. The outlet located at the top of the DAC unit 10 may also include a chimney 120.

Also shown in FIG. 2, the void space 80 may have a void height 140 that is equal to the distance from a solid supporting plane 90 beneath the DAC unit to the bottom of the DAC unit 10. The void height 140 may be greater than 0.5 m, greater than 1 m, and greater than 2 m. The solid supporting plane 90 may be any surface beneath the DAC unit 10, for example, the ground, a structure, a ship/vessel, or any other solid supporting plane that may provide support beneath the DAC unit 10.

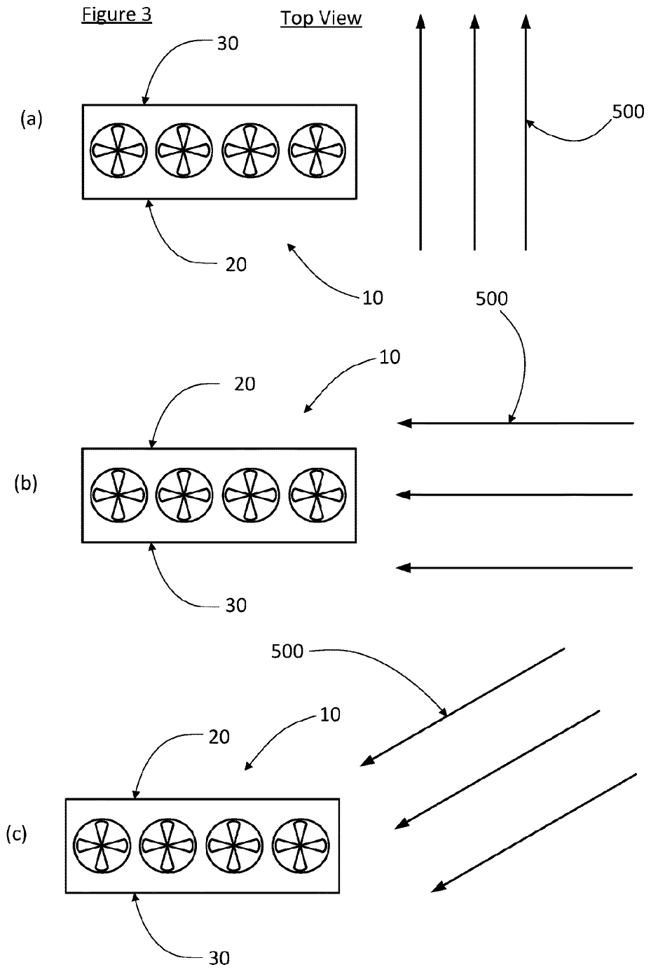

FIG. 3 shows an example process according to an implementation of the disclosed subject matter. In particular, FIG. 3 shows multiple top views of a DAC unit 10 according to an embodiment of the present invention. As shown in FIGS. 3(a)-(c), the DAC unit 10 may include a first inlet face 20 and a second inlet face 30. The wind direction of the ambient air 500 may be orthogonal to the second inlet face 30 (see FIG. 3 (a)), parallel to the second inlet face 30 (see FIG. 3 (b)) or at an angle to the second inlet face 30 (see FIG. 3 (c)). In the specific embodiments shown in FIGS. 3 (a) and (c), the second inlet face 30 may be a shadow inlet face. A shadow inlet face may be a downwind face when the wind direction is not parallel to the shadow inlet face.

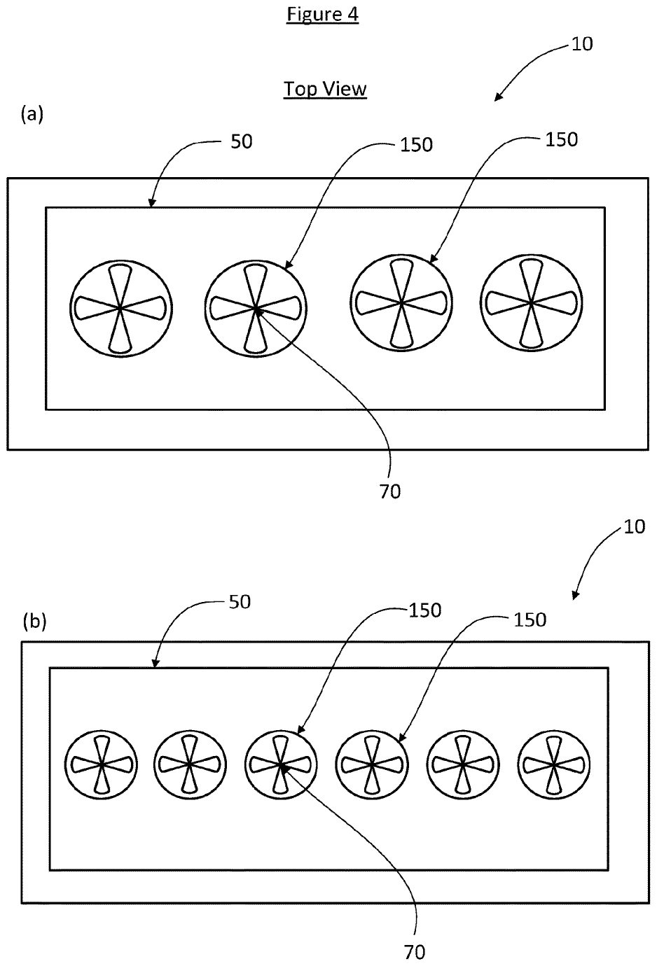

FIG. 4 shows an example process according to an implementation of the disclosed subject matter. In particular, FIG. 4 shows multiple top views of a DAC unit 10 according to an embodiment of the present invention. As shown, the DAC unit 10 may include an outlet 50 located at the top of the DAC unit 10. As shown in both FIGS. 4 (a) and (b), the outlet 50 may provide an exit gaseous outlet stream (not shown in FIG. 4), and the exit gaseous outlet stream may have a flow that is produced by at least one fan 70. As can be seen in FIGS. 4 (a) and (b), the outlet 50 located at the top of the DAC unit 10 may further comprise a plurality of exit channels 150. The exit velocity of the exit gaseous outlet stream may be based on the area of each exit channel 150. Further, each exit channel 150 may include a fan 70. FIG. 4 (a) shows an example outlet 50 including a plurality of exit channels 150 wherein each of the exit channels 150 in FIG. 4(a) has a relatively larger area as compared to the area of each of the exit channels 150 shown in FIG. 4(b). As such, according to the present invention, the flow and the exit velocity of the exit gaseous outlet stream may be controlled to a desired magnitude based on the area of each of the exit channels, number of exit channels, number of fans, etc. Further referring to FIG. 4, an exit channel 150 may further comprise a chimney (not shown).

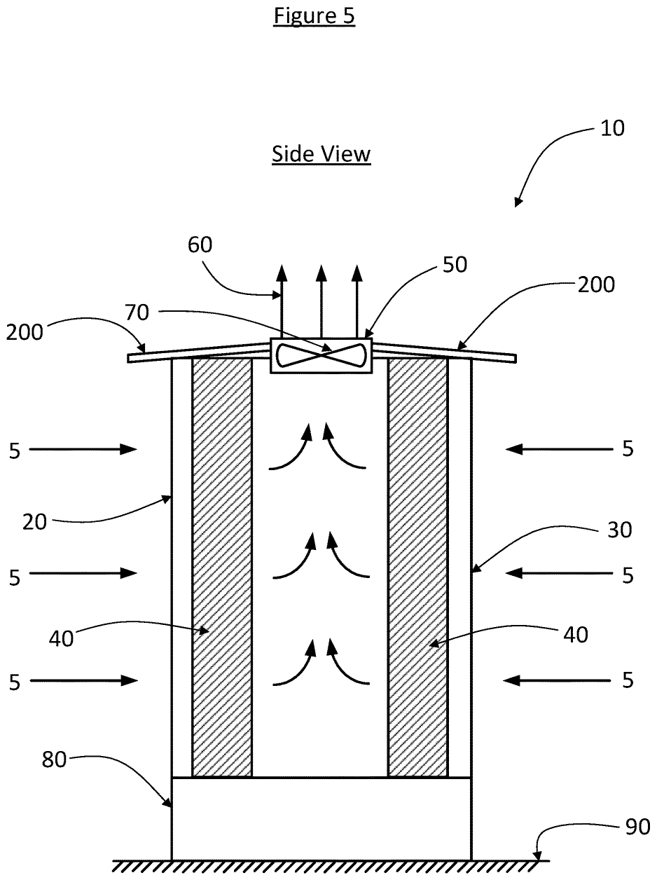

FIG. 5 shows an example process according to an implementation of the disclosed subject matter. In particular, FIG. 5 shows a side view of a DAC unit according to an embodiment of the present invention. As shown in FIG. 5, a process for capture of carbon dioxide from a gaseous feed stream 5 may include a direct air capture (DAC) unit 10. The DAC unit 10 may include 2 or more inlet faces 20, 30. As an example, the DAC unit 10 may include, as shown, a first inlet face 20 and a second inlet face 30. The first and second inlet faces 20,30 may be on opposite sides of the DAC unit 10, as shown in FIG. 5. As shown in FIG. 5, the DAC unit 10 may also include a sorbent material 40 located at or behind each of the inlet faces 20, 30 and the sorbent material 40 may be located inside the DAC unit 10.

According to an embodiment, as shown in FIG. 5, the DAC unit 10 may further comprise two louvers 200 located at the top of the DAC unit 10. The louvers 200 may extend proximate and at an angle relative to the first and second inlet faces 20,30. The DAC unit may also include more than two louvers located at the top of the DAC unit.

Also shown in FIG. 5, the DAC unit 10 may also include an outlet 50 located at the top of the DAC unit 10. The outlet 50 may provide an exit gaseous outlet stream 60, and the exit gaseous outlet stream 60 may have a flow that is produced by at least one fan 70. The DAC unit 10 may further comprise a void space 80 located beneath the DAC unit 10 and the DAC unit 10 may be supported by a solid supporting plane 90.

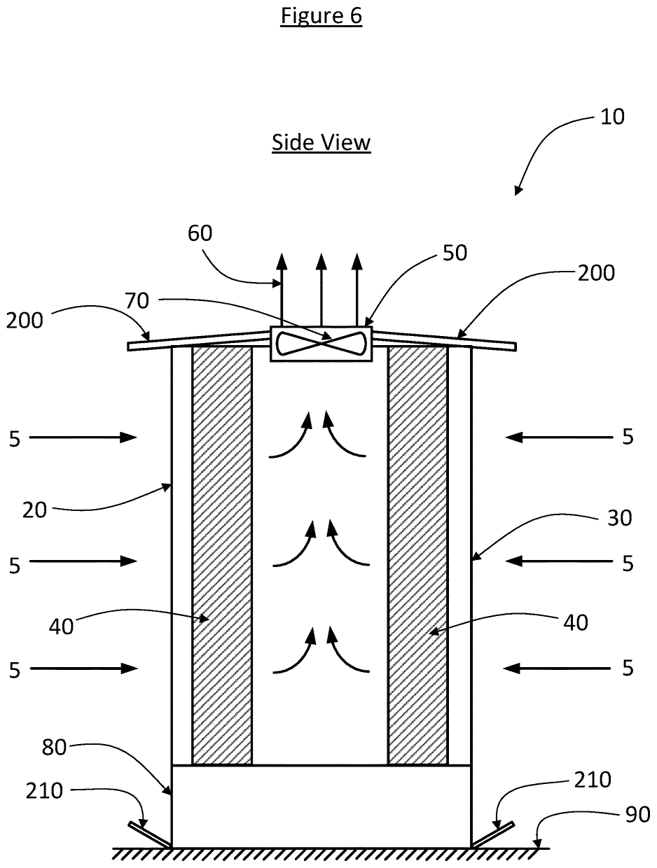

FIG. 6 shows an example process according to an implementation of the disclosed subject matter. In particular, FIG. 6 shows a side view of a DAC unit according to an embodiment of the present invention. As shown in FIG. 6, a process for capture of carbon dioxide from a gaseous feed stream 5 may include DAC unit 10. The DAC unit 10 may include 2 or more inlet faces 20, 30. As an example, the DAC unit 10 may include, as shown, a first inlet face 20 and a second inlet face 30. The first and second inlet faces 20,30 may be on opposite sides of the DAC unit 10, as shown in FIG. 6. As shown in FIG. 6, the DAC unit 10 may also include a sorbent material 40 located at or behind each of the inlet faces 20, 30 and the sorbent material 40 may be located inside the DAC unit 10.

According to an embodiment, as shown in FIG. 6, the DAC unit 10 may further comprise two louvers 200 located at the top of the DAC unit 10. The louvers 200 may extend proximate and at an angle relative to the first and second inlet faces 20,30. The DAC unit may also include more than two louvers located at the top of the DAC unit.

Additionally shown in FIG. 6, the DAC unit may also include two louvers 210 located at the bottom of the DAC unit. As shown, the bottom louvers 210 may extend proximate and at an angle relative to the first and second inlet faces. Although not shown, the DAC unit may also include more than two louvers located at the bottom of the DAC unit. According to another embodiment, the DAC unit may further include four louvers, where two louvers 200 are located at the top of the DAC unit and two louvers 210 are located at the bottom of the DAC unit. All four louvers 200,210 may extend proximate to the inlet faces, and each louver may extend at an angle relative to the two inlet faces.

Also shown in FIG. 6, the DAC unit 10 may also include an outlet 50 located at the top of the DAC unit 10. The outlet 50 may provide an exit gaseous outlet stream 60, and the exit gaseous outlet stream 60 may have a flow that is produced by at least one fan 70. The DAC unit 10 may further comprise a void space 80 located beneath the DAC unit 10 and the DAC unit 10 may be supported by a solid supporting plane 90.

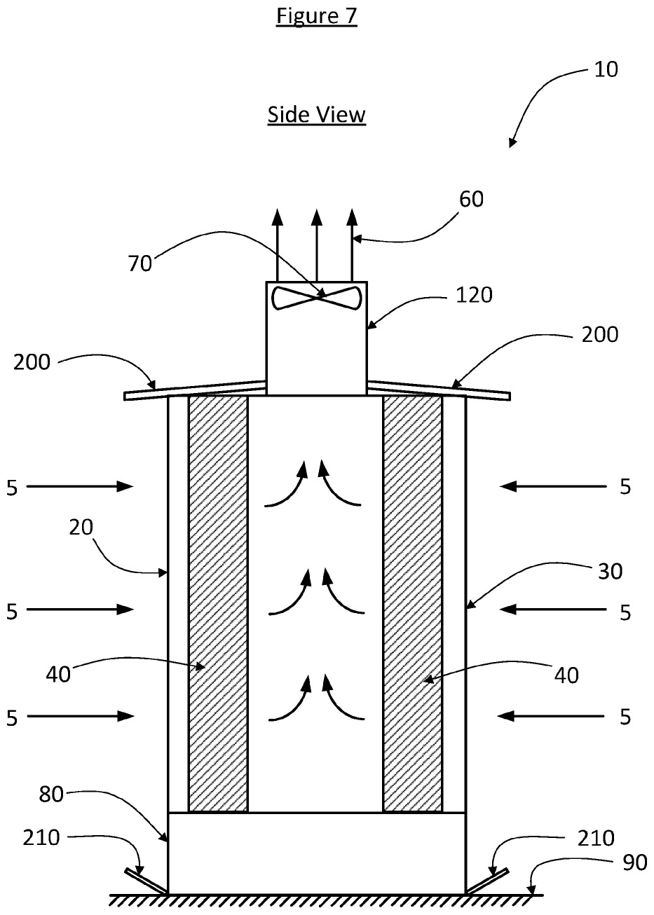

FIG. 7 shows an example process according to an implementation of the disclosed subject matter. In particular, FIG. 7 shows a side view of a DAC unit according to an embodiment of the present invention. FIG. 7 shows an embodiment in which all of the above features may be combined according to an implementation of the disclosed subject matter. As shown in FIG. 7, a process for capture of carbon dioxide from a gaseous feed stream 5 may include a direct air capture (DAC) unit 10. The DAC unit 10 may include 2 or more inlet faces 20, 30. As an example, the DAC unit 10 may include, as shown, a first inlet face 20 and a second inlet face 30. The first and second inlet faces 20,30 may be on opposite sides of the DAC unit 10, as shown in FIG. 7. As shown in FIG. 7, the DAC unit 10 may also include a sorbent material 40 located at or behind each of the inlet faces 20, 30 and the sorbent material 40 may be located inside the DAC unit 10.

According to an embodiment, as shown in FIG. 7, the DAC unit 10 may further comprise two louvers 200 located at the top of the DAC unit 10. The louvers 200 may extend proximate and at an angle relative to the first and second inlet faces 20,30. The DAC unit may also include more than two louvers located at the top of the DAC unit.

Additionally shown in FIG. 7, the DAC unit may also include two louvers 210 located at the bottom of the DAC unit. As shown, the bottom louvers 210 may extend proximate and at an angle relative to the first and second inlet faces. Although not shown, the DAC unit may also include more than two louvers located at the bottom of the DAC unit. According to another embodiment, the DAC unit may further include four louvers, where two louvers 200 are located at the top of the DAC unit and two louvers 210 are located at the bottom of the DAC unit. All four louvers 200,210 may extend proximate to the inlet faces, and each louver may extend at an angle relative to the two inlet faces.

Also shown in FIG. 7, the DAC unit 10 may also include an outlet 50 located at the top of the DAC unit 10. The outlet 50 may provide an exit gaseous outlet stream 60, and the exit gaseous outlet stream 60 may have a flow that is produced by at least one fan 70. The DAC unit 10 may further comprise a void space 80 located beneath the DAC unit 10 and the DAC unit 10 may be supported by a solid supporting plane 90. The outlet located at the top of the DAC unit 10 may also include a chimney 120.

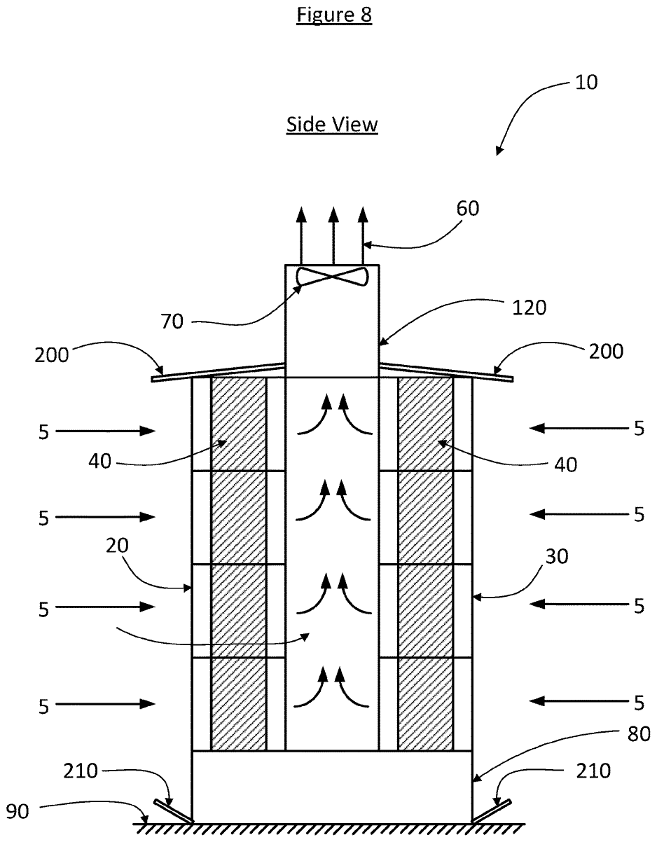

FIG. 8 shows an example process according to an implementation of the disclosed subject matter. In particular, FIG. 8 shows a side view of a DAC unit according to an embodiment of the present invention. FIG. 8 shows an embodiment where the sorbent material 40 may be contained in a stack of containers comprising partially or completely closed floors and ceilings, hence creating compartments or sections within the sorbent material 40 and/or inlet faces 20,30. Such containers may be, for example, standard or modified sea containers.

For the purposes of promoting an understanding of the principles of the invention, reference will now be made to the Examples carried out of various embodiments of the present invention, which are described in more detail below. The Examples and embodiments disclosed herein are not intended to be exhaustive or limit the invention to the precise form disclosed in the following Examples. The invention includes any alterations and further modifications in the provided Examples and described methods and further applications of the principles of the invention as set forth in the claims.

### EXAMPLES

A commercially available, multi-physics modeling software StarCCM+ was used to compute the fluid flow patterns and carbon dioxide concentration profiles for the air flow around the DAC unit. The dimensions of one container was set as 12.19 m×2.59 m×2.44 m. The direction of the incoming wind was set perpendicular to the first inlet face. The following Table 1 summarizes simulation results of different comparative embodiments according to implementation of the disclosed subject matter.

For each of the simulations, the ambient carbon dioxide concentration was set to be 400 parts per million by volume (ppmv). The wind direction was set to be perpendicular to the first inlet face of the DAC unit. Owing to the simulation configuration, the carbon dioxide concentration at the first inlet face was 400 ppmv. The average carbon dioxide concentration at the second inlet face 30 was different in the various comparative designs (as shown in column 2 in the Table 1). Column 3 in Table 1 compares the variation in the carbon dioxide concentration across the second inlet face among the various comparative designs. In these simulations, the second inlet face is the shadow inlet face. Column 4 in Table 1 compares the average carbon dioxide concentration on the first and the second inlet faces as a percentage of carbon dioxide concentration in the ambient air.

Comparative design 1 was a DAC unit with one container placed on the ground, wherein the long faces on the side were the inlet faces and the top face was the outlet.

Comparative design 2 was a DAC unit composed of four containers stacked vertically and placed on the ground, wherein the long faces on the side were the inlet faces and the top face of the top-most container was the outlet. Comparing the CO₂ concentrations at the inlet faces given in Table 1 for comparative designs 1 and 2 shows the advantageous effect of an increased height to length ratio of the DAC unit. As shown in Table 1, the CO₂ concentration at the second inlet face of the DAC unit with one container (i.e., height to length ratio less than 0.5) was 279 ppmv whereas the CO₂ concentration at the second inlet face of the DAC unit composed of a stack of four containers (i.e., height to length ratio greater than 0.5) was 331 ppmv. This demonstrates the superior CO₂ concentration at the second inlet face that is achieved when the height to length ratio of the DAC unit is increased.

Comparative design 3 was a DAC unit similar to comparative design 2 with a void space below the DAC unit. Comparing the CO₂ concentrations at the inlet faces given in Table 1 for comparative designs 2 and 3 shows the advantageous effect of a void space below the DAC unit. As shown in Table 1, the CO₂ concentration at the second inlet face of the DAC unit without a void space below was 331 ppmv whereas the CO₂ concentration at the second inlet face of the DAC unit with a void space below the DAC unit was 351 ppmv. This demonstrates the superior CO₂ concentration at the second inlet face that is achieved when there is a void space below the DAC unit.

Comparative design 4 was a DAC unit composed of a total of twelve containers, such that three columns were each composed of four vertically stacked containers, wherein the left face of the left vertical stack and right face of the right vertical stack were the inlet faces. The outlet is located on the top with an area of 29.7 m². There was also a void space below the DAC unit.

Comparative design 5 was a DAC unit similar to comparative design 4 with the addition of a chimney located on the outlet with an area of 29.7 m². Comparing the CO₂ concentrations at the inlet faces given in Table 1 for comparative designs 4 and 5 shows the advantageous effect of a chimney located on the outlet of the DAC unit. As shown in Table 1, the CO2 concentration at the second inlet face without a chimney located at the outlet of the DAC unit was 347 ppmv whereas the CO₂ concentration at the second inlet face with a chimney located at the outlet of the DAC unit was 356 ppmv. This demonstrates the superior CO₂ concentration at the second inlet face that is achieved when a chimney is located at the outlet of the DAC unit.

Comparative design 6 was a DAC unit similar to comparative design 4, except that the outlet area was reduced to 14.8 m². Comparing the CO₂ concentrations at the inlet faces given in Table 1 for comparative designs 4 and 6 shows the advantageous effect of increasing the velocity of the exit gaseous outlet stream of the DAC unit. As shown in Table 1, the CO₂ concentration at the second inlet face of the DAC unit with an outlet area of 29.7 m² was 347 ppmv whereas the CO₂ concentration at the second inlet face of the DAC unit with an outlet area of 29.7 m² was 379 ppmv. This demonstrates the superior CO₂ concentration at the second inlet face that is achieved when the velocity of the exit gaseous stream of the DAC unit is increased.

Comparative design 7 was a DAC unit similar to comparative design 5, except that the chimney had an outlet area of 22.3 m². Comparing the CO₂ concentrations at the inlet faces given in Table 1 for comparative designs 5 and 7 shows the advantageous effect of increasing the velocity of the exit gaseous outlet stream of the DAC unit. As shown in Table 1, the CO₂ concentration at the second inlet face of the DAC unit with an outlet area of 29.7 m² was 356 ppmv whereas the CO₂ concentration at the second inlet face of the DAC unit with an outlet area of 22.3 m² was 388 ppmv. This demonstrates the superior CO₂ concentration at the second inlet face that is achieved when the velocity of the exit gaseous stream of the DAC unit is increased.

Comparative design 8 was a DAC unit similar to comparative design 5 with louvers on the top of the unit extending perpendicular to the two inlet faces. Comparing the CO₂ concentrations at the inlet faces given in Table 1 for comparative designs 5 and 8 shows the advantageous effect of louvres at the top of the DAC unit. As shown in Table 1, the CO₂ concentration at the second inlet face of the DAC unit without louvres was 356 ppmv whereas the CO₂ concentration at the second inlet face of the DAC unit with louvres was 385 ppmv. This demonstrates the superior CO₂ concentration at the second inlet face that is achieved when there are louvres on the top of the DAC unit.

As demonstrated and shown in column 4 of Table 1, comparative designs 5, 6, 7 and 8 (according to implementations of the disclosed subject matter) had an average carbon dioxide concentration on the inlet faces to be greater than or equal to 95% of the carbon dioxide concentration in the ambient air.

Table 1 below shows the CO₂ concentrations of the second inlet face, CO₂ concentration variations on the second (shadow) inlet face and average CO₂ concentration on all inlet faces for the different designs according to various embodiments of the disclosed invention. Average CO₂ concentration on all inlet faces is the average of the CO₂ concentration simulated at the first and the second (shadow) inlet faces.

| | | CO₂ | Average CO₂ |
|---|---|---|---|
| | CO₂ | concentration | concentration |
| | concentration | variation | on all inlet faces |
| | of the second | on the second | (expressed as |
| | (shadow) inlet | (shadow) inlet | % of ambient |
| Design name | face (ppmv)* | face(±ppmv) | air concentration) |
| Comparative | 279 | 20 | 85 |
| design 1 | | | |
| Comparative | 331 | 1 | 91 |
| design 2 | | | |
| Comparative | 351 | 9 | 94 |
| design 3 | | | |
| Comparative | 347 | 12 | 93 |
| design 4 | | | |
| Comparative | 356 | 11 | 95 |
| design 5 | | | |
| Comparative | 379 | 11 | 97 |
| design 6 | | | |
| Comparative | 388 | 3 | 99 |
| design 7 | | | |
| Comparative | 385 | 3 | 98 |
| design 8 | | | |

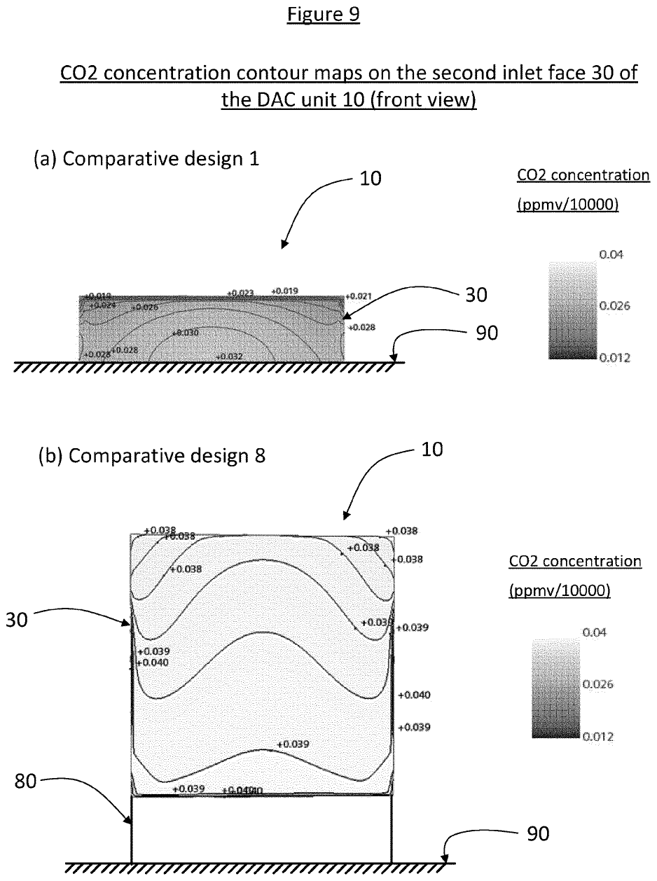

FIG. 9 shows the carbon dioxide concentration contours on the second inlet face 30 of the DAC unit 10 for comparative design 1 (as shown in FIG. 9 (a)) and comparative design 8 (as shown in FIG. 9 (b)) obtained by the modeling software according to implementation of the disclosed subject matter. The solid supporting plane 90 is shown in the FIGS. 9 (a) and (b) since the DAC unit 10 was placed on the solid supporting plane 90 in comparative design 1 and has a void space 80 below the DAC unit 10 for comparative design 8. As shown in the gray scale contour map legend shown on the right, the darker the shade of grey on the face, the lower the carbon dioxide concentration. Thus, as can be seen by comparing FIGS. 9(a) and 9(b), comparative design 8 shows higher carbon dioxide concentration as compared to comparative design 1. Moreover, the contour lines shown on the inlet face indicate the CO₂ concentration values across the second inlet face 30. As can be seen by comparing the counter lines shown in FIGS. 9(a) and (b), comparative design 1 has a higher variation in CO₂ concentration as compared to comparative design 8 (also shown in column 3 of Table 1). These two factors demonstrate that comparative design 8 is a superior design as it provides higher average carbon dioxide concentration at the second inlet face 30 and lower variation in the carbon dioxide concentration across the second inlet face 30, which is indicative of a higher productivity of the DAC unit 10.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A process for capture of carbon dioxide from a gaseous feed stream, the process comprising:
a) a direct air capture (DAC) unit comprising:
1) a first inlet face and a second inlet face, wherein the first and second inlet faces are on opposite sides of the DAC unit;
2) a sorbent material located at or behind each of the first and second inlet faces and wherein the sorbent material is located inside the DAC unit; and
3) an outlet located at the top of the DAC unit, wherein the outlet provides an exit gaseous outlet stream, and wherein the exit gaseous outlet stream has a flow that is produced by at least one fan;
b) receiving a gaseous feed stream at each of the first and second inlet faces, wherein the gaseous feed stream has an average CO₂ concentration greater than 95% of the CO₂ concentration of ambient air by minimizing reingestion of the exit gaseous outlet stream, and wherein the ambient air has any wind direction and any wind speed.

2. The process for capture of carbon dioxide from a gaseous feed stream according to claim 1, wherein the second inlet face is a shadow inlet face that is a downwind face when the wind direction is not parallel to the shadow inlet face.

3. The process for capture of carbon dioxide from a gaseous feed stream according to claim 1, wherein the DAC unit further comprises:
1) an inlet air section,
2) a sorbent section, and
3) an outlet air section,
and wherein the process further comprises:
b) receiving the gaseous feed stream at the inlet air section,
c) contacting at least part of the gaseous feed stream with the sorbent material which is located within the sorbent section,
d) providing the exit gaseous outlet stream from the outlet air section,
wherein the total pressure loss across the inlet and outlet air sections is maintained at less than 200 Pa;
wherein the gaseous feed stream has a volumetric flow within the sorbent section,
wherein the volumetric flow has a maximum flow and a minimum flow, and
wherein the DAC unit further comprises at least one structural element for maintaining the minimum flow to be within a range of 0-20% lower than the maximum flow over the entire sorbent section.

4. The process for capture of carbon dioxide from a gaseous feed stream according to claim 1 wherein the DAC unit has a height that is equal to the distance between the top and bottom of the DAC unit and the DAC unit has a length that is equal to the length of the longest of the first and second inlet faces, and wherein the DAC unit has a height/length ratio of greater than 0.5

5. The process for capture of carbon dioxide from a gaseous feed stream according to claim 1 wherein the exit gaseous outlet stream has an exit velocity of less than 15 m/s and greater than 2 m/s.

6. The process for capture of carbon dioxide from a gaseous feed stream according to claim 5, wherein the outlet located at the top of the DAC unit further comprises a plurality of exit channels, and wherein the exit velocity of the exit gaseous outlet stream is based on the area of each exit channel in the plurality of exit channels.

7. The process for capture of carbon dioxide from a gaseous feed stream according to claim 6, wherein each exit channel in the plurality of exit channels comprises a fan.

8. The process for capture of carbon dioxide from a gaseous feed stream according to claim 1 wherein the outlet located at the top of the DAC unit further comprises a chimney.

9. The process for capture of carbon dioxide from a gaseous feed stream according to claim 1 wherein the DAC unit further comprises two louvers located at the top of the DAC unit, and wherein the louvers extend proximate and at an angle relative to the first and second inlet faces.

10. The process for capture of carbon dioxide from a gaseous feed stream according to claim 1 wherein a void space is located beneath the DAC unit, and wherein the void space has a void height that is equal to the distance from a solid supporting plane beneath the DAC unit to the bottom of the DAC unit, and wherein the void height is greater than 0.5 m.

11. The process for the capture of carbon dioxide from a gaseous feed stream according to claim 1 wherein the DAC unit further comprises two louvers located at the bottom of the DAC unit, and wherein the louvers extend proximate and at an angle relative to the first and second inlet faces.

12. The process for the capture of carbon dioxide from a gaseous feed stream according to claim 1 wherein the DAC unit further comprises four louvers wherein two louvers are located at the top of the DAC unit and two louvers are located at the bottom of the DAC unit, and wherein the four louvers extend proximate and each at an angle relative to the two inlet faces.
